(19) United States
(12) Patent Application Publication
(10) Pub. No.: US 2006/0090182 A1
(43) Pub. Date: Apr. 27, 2006

(54) Method and system for multimedia advertising

(75) Inventors: David B. Horowitz, Wallingford, PA (US); Benjamin R. Rudolph, Philadelphia, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Interactive Capital, LP, Wilmington, DE (US)

(21) Appl. No.: 10/974,323

(22) Filed: Oct. 27, 2004

(51) Int. Cl. H04N 5/445; G06F 13/00; G06F 3/00

(52) U.S. Cl. 725/40

(57) ABSTRACT

Method and system for multimedia advertising. The multimedia advertising including video and content information. The advertisements being accessible for viewing the video and content information associated therewith.

### BACKGROUND OF THE INVENTION

1. Field of the Invention

The present invention relates to methods and systems of multimedia advertising.

2. Background Art

It is believed that multimedia advertising, and in particular television or video commercials, is the most effective method of advertising products and services. Television commercials, for example, are one of the more common types of multimedia advertisements. The commercials typically run from 30 to 60 seconds and air on broadcast or cable television and are advantageous because they allow advertisers to reach a broad geographical area with a single advertisement. In fact, some advertisements air across the nation, such as during the Super Bowl and other nationally televised events.

The disadvantage of television commercials is that it may be cost prohibitive for some advertisers to purchase air time on broadcast or cable television channels. As such, these advertisers are left with secondary advertising sources, such as print advertising. Print advertising is more cost effective than television commercials but, typically, less persuasive.

Accordingly, what is needed is a cost effective means for providing multimedia advertising.

### SUMMARY OF THE INVENTION

The present invention contemplates a number of features and configurations for multimedia advertising, including a system having a multimedia interface for creating multimedia advertisements for a plurality of advertisers. The multimedia advertisements preferably include video and content information.

In accordance with one aspect of the present invention, the multimedia interface is accessible through a webpage. The webpage preferably includes features for recording video and associating content information, such as a title, product description, and the like, with the advertisement. The webpage is preferably accessible to advertisers so that the advertiser can easily change the video and/or content information of their advertisement.

In accordance with one aspect of the present invention, the multimedia interface is accessible to personnel of the service provider, such as personnel at a headend of a cable service provider. In this manner, the personnel may input the video and content information for creating the advertisement. In particular, the advertiser may simply email dialogue and other advertising content to the operators such that the operators create the advertisement at the headend for the advertisers, such as by hiring their own actors and using recording equipment at the headend.

The system preferably includes a navigatable database in communication with the multimedia interface for automatically storing the multimedia advertisements. The stored advertisements are preferably accessible through a navigation interface such that customers may navigate the database for desired advertisements. Preferably, the database is navigatable according to content information associated with the advertisers.

In accordance with one aspect of the present invention, the navigation interface is accessible through an electronic programming guide (EPG). In this manner, a settop box or other device of a subscriber of the service provider may access the EPG for searching the advertisements.

In accordance with another aspect of the present invention, the navigation interface is accessible through a webpage. In this manner, a user may access the webpage to search through the advertisements.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a system for multimedia advertising in accordance with one aspect of the present invention;

FIG. 2 illustrates a multimedia interface in accordance with one aspect of the present invention;

FIG. 3 illustrates a navigation interface in accordance with one aspect of the present invention;

FIG. 4 illustrates a ‘Yellow’ menu in accordance with one aspect of the present invention;

FIG. 5 illustrates a ‘Food & Dining’ menu in accordance with one aspect of the present invention;

FIG. 6 illustrates a ‘Japanese’ menu in accordance with one aspect of the present invention; and

FIG. 7 illustrates an advertisement interface in accordance with one aspect of the present invention.

### DETAILED DESCRIPTION OF THE PREFERRED EMBODIMENT(S)

FIG. 1 illustrates a system 10 for on-demand multimedia advertising in accordance with one aspect of the present invention. The system 10 generally relates to a cable system and preferably includes a cable headend 14, a network 16, and a user access point 20. Cable services of a cable service provider are delivered from the headend 14 over the network 16 to the user access point 20. The system 20 shown in FIG. 1 is one exemplary embodiment of the present invention in a cable network and is not intended to limit the scope and contemplation of the present invention, as the present invention contemplates its application in other systems and environments beyond cable systems.

The user access point 20 may include any number of features for communicating with the headend 14, such as a settop box (STB), a computer, and the like. The network 16 may include any type of network, such as a public telephone switching network (PTSN), a fiber cable network, a wireless network, and the like. In this manner, the headend 14 may provide television, high speed data, and other services over the network 16 to a subscriber at the user access point 20.

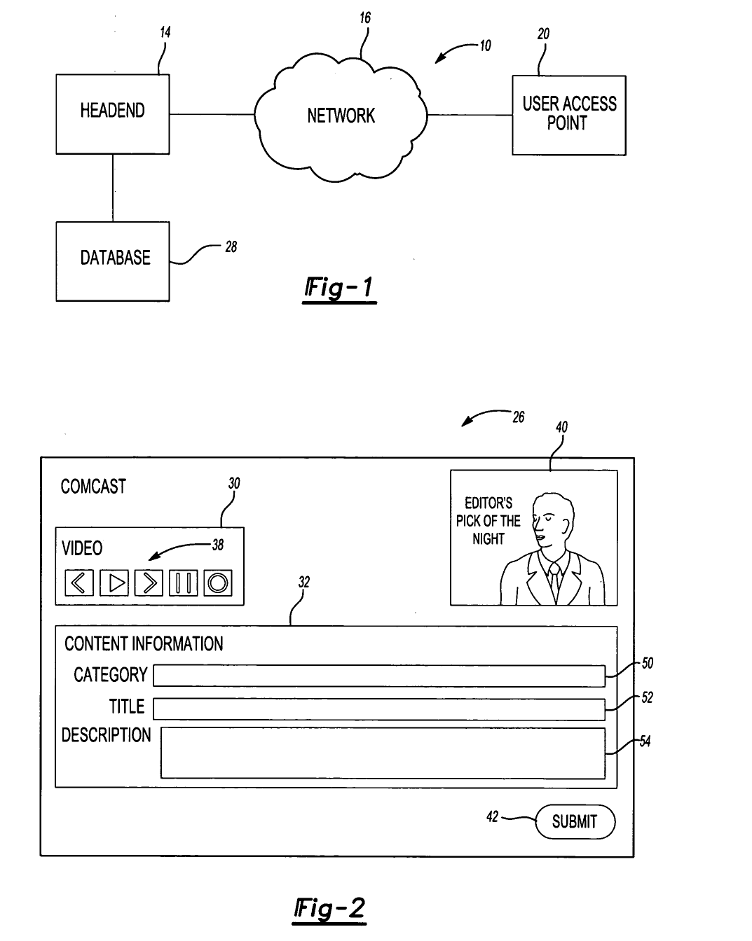

FIG. 2 illustrates a multimedia interface 26 in accordance with one aspect of the present invention. The multimedia interface 26 is generally a graphical user interface (GUI) configured for inputting multimedia advertisements into a database 28 (See FIG. 1) of the headend 14 for storage. The multimedia interface 26 includes capabilities for creating an advertisement having video and content information, which are added through a video menu 30 and a content information menu 32.

The video menu 30 includes a number of buttons 38 for rewinding, playing, forwarding, pausing, and recording video. The video is shown in a display window 40. The video may be recorded directly from a device attached to user access point 20, such as the user's computer, and delivered over the network 16 to the headend 14, it may be emailed or otherwise sent to the headend 14, and/or it may be created by operators at the headend 14. The video is displayed in the display window 40 during recording and playback. A user may manipulate the video menu 30 to control playing, recording, and editing of the video. A submit button 42 is provided for submitting the video and content information to the database 28.

The content menu 32 includes a number of input fields for receiving content information that is to be associated with the video. Together, the video and content information define the multimedia advertisement. The content menu 32 may include any number of input fields for associating content information with the video, including a category field 50, a title field 52, and a description field 54. The category field 50 indicates the type of service provided by the advertiser, the title field 52 indicates the name, phone number, and address of the advertiser's business or service, and the description field 54 describes the advertiser's business or product that is the subject of the advertisement. Of course, any number of additional input fields may be included without deviating from the scope and contemplation of the present invention.

The multimedia interface 26 may be provided through a webpage hosted by the headend 14 or other entity and/or through an application program that runs on the user's computer. Preferably, it is a standard application that may run through the webpage or on the user's computer to record or edit multimedia video and input the content information. For example, an advertiser may access the interface 26 through a webpage and record the video through a video recorder attached to their home computer and/or they may upload previously recorded video from their home computer. In addition, operators at the headend unit may input the video and content information for the advertisers on-site so that the advertisers may simply email or otherwise deliver their video and content information to the headend operators for the operators to input the information into the database 28. In particular, the advertisers may specify dialogue and other advertising content of the advertisement so that operators at the headend 14 may create the advertisement for the advertiser, such as by hiring actors and filming the advertisement using on-site equipment. Preferably, the video and content information may be updated to include new video or new content information so that the advertisers may easily update their advertisements, such as to describe daily specials and/or seasonal events.

The multimedia interface 26, as described above, is configured for recording video, which may then be used for on demand viewing. The present invention, however, is not so limited. Rather, other multimedia elements are contemplated for the advertisements, such as narrated and unarrated slide-shows. For example, the video menu 30 may be replaced with a slide-show menu (not show) that may be used to search a computer hard-drive, a remote database, such as an interactive two-way plant, and/or a removable storage medium for digital pictures, art, and the like such that the pictures may be selected for playing in a slide-show. In addition, the slide-show menu may include features for including audio and other special effects with the pictures, if desired to provide a narrated slide-show. Furthermore, other multimedia elements, such as interactive gaming and other interactive features are contemplated for the advertisements. In particular, the present invention contemplates carouseling interactive applications that permit the user to interact with the advertisement.

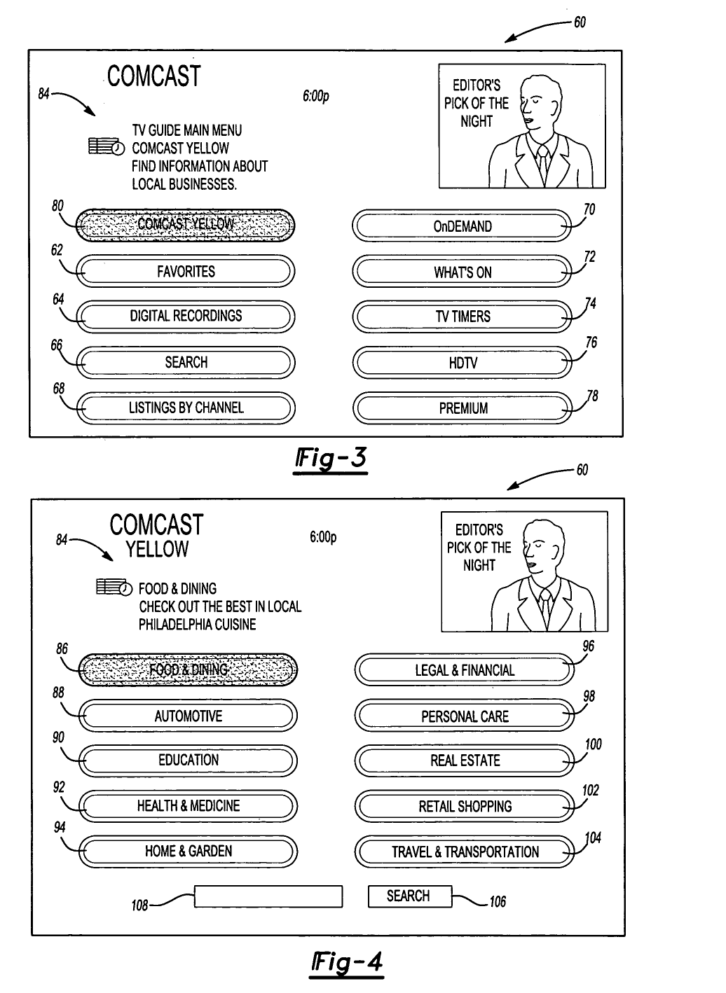

FIG. 3 illustrates a navigation interface 60 for navigating the database 28 to locate desired advertisements in accordance with one aspect of the present invention. The navigation interface 60, like the multimedia interface 26, is a GUI that may be accessed through a webpage hosted by the headend 14 and/or operated as a standalone item on a user computer. In addition, it may be integrated into an electronic programming guide (EPG) that operates on a STB of a subscriber of the cable service provider. For exemplary purposes, FIG. 3 illustrates the navigation interface 60 being accessed through an EPG, however, as will be readily apparent from the discussion below, the navigation interface may be similarly accessed through a webpage to locate desired advertisements.

As shown, the navigation interface (EPG) 60 includes a number of selectable buttons and menus for providing typical EPG operations, such as a ‘Favorites’ button 62, a ‘Digital Recordings’ button 64, a ‘Search’ button 66, a ‘Listings by Channel’ button 68, a ‘OnDemand’ button 70, a ‘What's On’ button 72, a ‘TV Timers’ button 74, a ‘HDTV’ button 76, and a ‘Premium’ button 78. In accordance with one aspect of the present invention, the navigation interface 60 further includes a ‘Yellow’ button 80. A display window 84 provides information regarding a highlighted button, which is shown to be the ‘Yellow’ button 80.

FIG. 4 illustrates selection of the ‘Yellow’ button 80 in accordance with one aspect of the present invention. This selection corresponds with a desire to perform a so-called ‘Yellow Pages’ search to located advertisements of local business, such as to locate a business selling goods or services. As shown, a number of category buttons appear in the interface 60 with selection the ‘Yellow’ button 80. The categories shown are provided to assist the user in locating an advertisement for a desired product or service. Of course, more or less of these categories may be shown.

The category buttons include, but are not limited to, a ‘Food & Dining’ button 86, an ‘Automotive’ button 88, an ‘Education’ button 90, a ‘Health & Medicine’ button 92, a ‘Home & Garden’ button 94, a ‘Legal & Financial’ button 96, a ‘Personal Care’ button 98, a ‘Real Estate’ button 100, a ‘Retail Shopping’ button 102, and a ‘Travel & Transportation’ button 104. The display window 84 provides a textual description for a geographical area associated with the highlighted category button. In particular, the window 84 notes that the ‘Food & Dining’ button 86 is highlighted, such as with a cursor or other pointing item, and that selection of this button 86 corresponds with the best in local Philadelphia cuisine. The geographical area of Philadelphia is preferably learned with location logic from a user profile of the user and/or through a network address associated with the user access point through which the user accesses the navigation interface 60. Preferably, the advertisements located for each category are sorted according to the geographical area of the user so that local advertisements are located first. In addition, a search button 106 is preferably included for locating advertisements associated with search criteria inputted into a search field 108, such as textual description on content information likely to be found in the title or description of the advertisements and/or some other advertisement locating indicator.

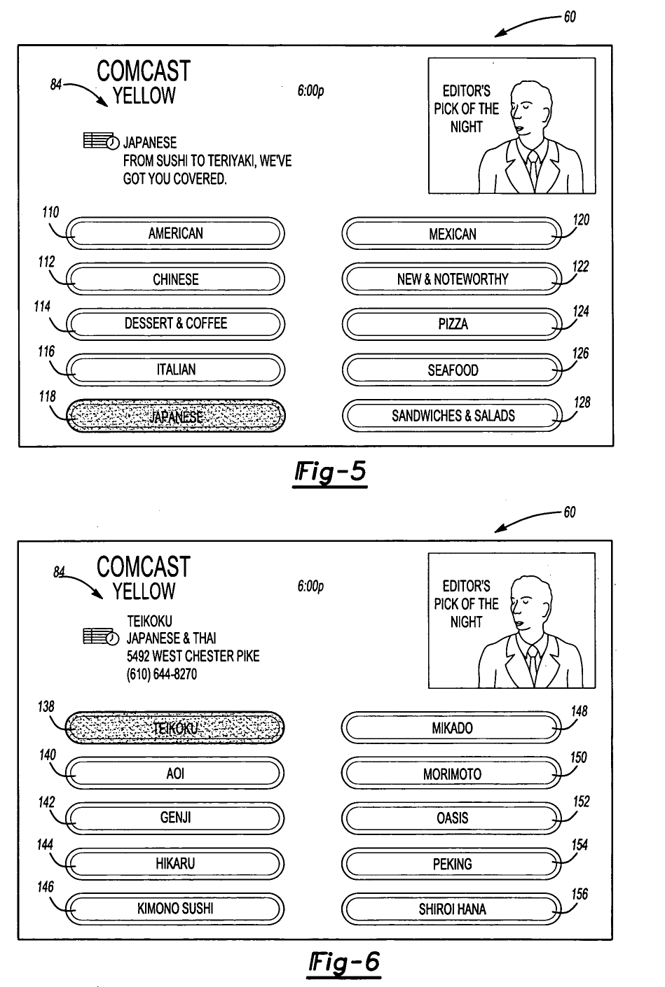

FIG. 5 illustrates selection of the ‘Food & Dining’ button 86 in accordance with one aspect of the present invention. This selection corresponds with a desire to locate advertisements of local business providing ‘Food & Dining’ services or products. As shown, a number of sub-category buttons appear with selection the ‘Yellow’ button. The sub-categories shown are provided to assist the user in further narrowing the search of advertisement for the desired product or service. Of course, more or less of these sub-categories may be shown.

The sub-category buttons include, but are not limited to, an ‘American’ button 110, a ‘Chinese’ button 112, a ‘Desert & Coffee’ button 114, an ‘Italian’ button 116, a ‘Japanese’ button 118, a ‘Mexican’ button 120, a ‘News & Noteworthy’ button 122, a ‘Pizza’ button 124, a ‘Seafood’ button 126, and a ‘Sandwiches & Salads’ button 128. The display window 84 provides a textual description for a highlighted sub-category, which is shown to be the sub-category indicated with the ‘Japanese’ button 118.

FIG. 6 illustrates selection of the ‘Japanese’ button 118 in accordance with one aspect of the present invention. This selection corresponds with a desire to locate advertisements of local Japanese businesses providing ‘Food & Dining’ services or products. As shown, titles for a number of business listings appear for each business having an advertisement in the database 28. Each listing appears with a button that may be selected for on-demand access to an advertisement provided by the advertiser. The titles are each associated with a button, such as a ‘Teikoku’ button 138, a ‘Aoi’ button 140, a ‘Genji’ button 142, an ‘Hikaru’ button 144, a ‘Kimono Sushi’ button 146, a ‘Mikado’ button 148, a ‘Morimoto’ button 150, a ‘Oasis’ button 152, a ‘Peking’ button 154, and a ‘Shiroi Hana’ button 156. The display window 84 provides a textual description for a highlighted listing to indicate the title of the business and its telephone number and address, which is shown to be the ‘Teikoku’ listing. In this manner, the user may flip through the listing to view phone numbers and addresses without viewing the advertisements associated therewith. Preferably, the advertisements are displayed according to geographical areas, such as by displaying the advertisements associated with advertisers closest to the user in an upper-left portion of the columns of buttons and ascending therefrom based on geographical area for the other advertisements.

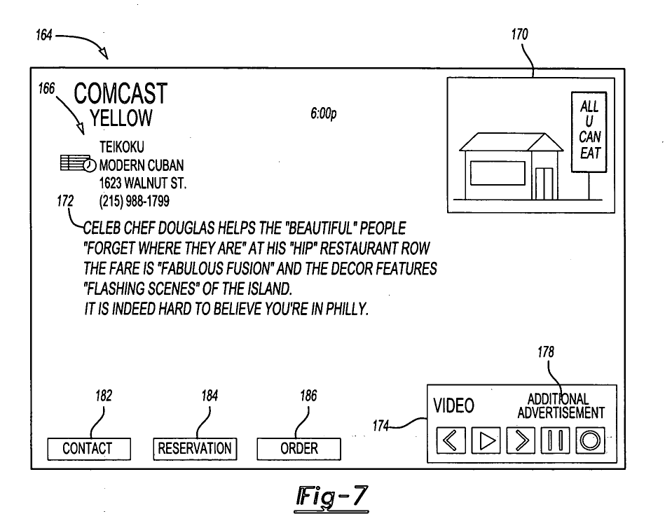

FIG. 7 illustrates an advertisement interface 164 for viewing a selected listing, such as those shown in FIG. 6 in accordance with one aspect of the present invention. In this example, the advertisement interface 164 is for the ‘Teikoku’ listing. The advertisement interface 164 includes a title portion 166 for displaying the title of the advertising business and its address and phone number, a display window 170 for displaying the video associated with the advertisement, and a description portion 172 for displaying the description associated with the advertisement. A video menu 174 having a number of video buttons may be included for rewinding, playing, forwarding, and pausing the video. The video menu 174 further includes an optional ‘Additional Advertisement’ button 178. The button 178 may be selected for viewing additional video or other multimedia associated with the advertisements, such as a daily specials video, video of other products, and the like.

The advertisement interface 164 further includes a ‘Contact’ button 182, a ‘Reservation’ button, 184, and an ‘Order’ button 186. These buttons are generally referred to as commerce buttons because they permit the user to interact with the business associated with the advertisement. The ‘Contact’ button 182 calls up a new menu (not show) or other interface that permits the user to email the advertiser, and optional, a phone interface that permits the user to communicate direct through the EPG with the advertiser. The ‘Reservation’ button 184 calls up a new menu (not show) or other interface that permits the user to make a reservation, such as for dinner, with the advertiser. The ‘Order’ button 186 calls up a new menu (not show) or other interface that permits the user order carry-out or home-delivery from the advertiser.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for multimedia advertising, the system comprising:
a multimedia interface for creating multimedia advertisements for a plurality of advertisers, the multimedia advertisements including video and content information for the advertisers;
a navigatable database in communication with the multimedia interface for automatically storing the multimedia advertisements; and
a navigation interface for navigating the database based on the content information associated with the advertisers so that a user may navigate the database for on-demand accessing of the multimedia advertisements.

2. The system of claim 1 wherein the navigation interface is accessible through an electronic programming guide (EPG).

3. The system of claim 2 wherein the EPG is accessible through a settop box.

4. The system of claim 1 wherein the navigation interface is accessible through a webpage.

5. The system of claim 1 wherein the multimedia interface is accessible through a webpage for updating the multimedia advertisements, wherein an updated multimedia advertisement is automatically stored on the database.

6. The system of claim 5 wherein the updated multimedia advertisement includes new video.

7. The system of claim 5 wherein the wherein the updated multimedia advertisement includes new content information.

8. The system of claim 1 wherein the navigation interface includes a graphical user interface (GUI) having a number of selectable menu buttons for locating the content information.

9. The system of claim 8 wherein at least one of the menu buttons includes a services category button for locating multimedia advertisements sorted according to services provided by the advertisers.

10. The system of claim 8 wherein at least one of the menu buttons includes a search button for locating advertisements associated with inputted search criteria.

11. The system of claim 1 wherein the navigation interface includes location logic for locating advertisers associated with a geographical area.

12. The system of claim 11 wherein the geographical area is determined from a user input to the navigation interface.

13. The system of claim 11 wherein the geographical area is determined automatically from a user profile of the user stored on the database.

14. The system of claim 11 wherein the geographical area is determined from a network address that corresponds with a network device used by the user to access the navigation interface.

15. The system of claim 1 further comprising an advertisement interface for playing video and displaying content information associated with the multimedia advertisement.

16. An electronic programming guide (EPG) for selecting multimedia advertisements, the multimedia advertisements each including video and content information, the EPG comprising:
an advertisement navigation menu for navigating a database of multimedia advertisements according to the content information associated with the advertisements and displaying the video and content information of the advertisements.

17. The EPG of claim 16 wherein the navigation menu displays one or more titles for the advertisements such that the video and content information associated with the advertisements is available through the EPG for on-demand viewing with selection of one of the titles.

18. The EPG of claim 17 wherein an advertisement interface appears with selection of one of titles, the advertisement interface including a display portion for displaying the content information and a video portion for playing the video associated with the selected advertisement.

19. A method for multimedia advertising, the method comprising:
storing multimedia advertisements in a navigatable database, each multimedia advertisement including video and content information; and
receiving navigation signals for navigating the database based on the content information associated with the advertisements such that the advertisements are accessible through an advertisement interface for on-demand viewing of the video and content information.

20. The method of claim 19 further comprising receiving the navigation signals through an electronic programming guide (EPG).

21. The method of claim 19 further comprising receiving the navigation signals through a webpage.

22. The method of claim 19 further comprising receiving the video and content information for the advertisements through a webpage hosted by a service provider and storing the received video and content information in the database.

23. The method of claim 19 further comprising receiving the video and content information for the advertisements through email and storing the emailed video and content information in the database.

24. The method of claim 19 further comprising creating the video and content information for the advertisements at a headend of a service provider.

25. The method of claim 24 further comprising receiving dialogue and advertising content from an advertiser and creating the advertisement according to the dialogue and advertising content.

26. The method of claim 25 further comprising receiving the dialogue and advertising content through email.

27. The method of claim 19 further comprising displaying the advertisements in an electronic programming guide (EPG).

28. The method of claim 19 further comprising displaying the advertisements in a webpage.

29. A method for multimedia advertising, the method comprising:
creating multimedia advertisements having video and content information, the content information including a title and description for the advertisement;
storing the multimedia advertisements in a navigatable database;
searching the database according to the advertisement titles; and
selecting one of the titles for on-demand viewing of the advertisement, the on-demand viewing including displaying the video and description associated with the selected advertisement.

30. The method of claim 29 further comprising displaying the selected advertisement in an electronic programming guide (EPG).

31. The method of claim 29 further comprising displaying the selected advertisement in a webpage.

32. The method of claim 29 further comprising creating the advertisements through a webpage hosted by a service provider.

33. The method of claim 29 further comprising creating the advertisements on a personal computer and emailing the advertisement to a service provider having the database.

34. The method of claim 29 further comprising creating the advertisements at a headend of a service provider.

35. The method of claim 34 further comprising receiving dialogue and advertising content from an advertiser and creating the advertisement according to the dialogue and advertising content.

36. A method for multimedia advertising, the method comprising:
storing multimedia advertisements in a navigatable database, each multimedia advertisement including a multimedia feature and content information; and
receiving navigation signals for navigating the database based on the content information associated with the advertisements such that the advertisements are accessible through an advertisement interface for on-demand viewing of the multimedia feature and content information.

37. The method of claim 36 further comprising storing video as the multimedia feature.

38. The method of claim 36 further comprising storing a slide-show as the multimedia feature.

39. The method of claim 38 further comprising receiving the navigation signals through an electronic programming guide (EPG).

40. The method of claim 38 further comprising receiving the navigation signals through a webpage.

41. The method of claim 38 further comprising receiving the slide-show and content information for the advertisements through a webpage hosted by a service provider and storing the received slide-show and content information in the database.

42. The method of claim 38 further comprising receiving the slide-show and content information for the advertisements through email and storing the emailed slide-show and content information in the database.

43. The method of claim 38 further comprising creating the slide-show and content information for the advertisements at a headend of a service provider.

44. The method of claim 36 further comprising displaying the accessed advertisements in the advertisement interface, the advertisement interface including a ‘Contact’ button for contacting the advertiser, a ‘Reservation’ button for making a reservation with the advertiser, and a ‘Order’ button for ordering from the advertiser.

45. The method of claim 36 further comprising displaying additional multimedia features for each accessed advertisement in response to selection of an ‘Additional Advertisement’ button provided in the advertisement interface.
